(19) United States
(12) Patent Application Publication
(10) Pub. No.: US 2019/0366627 A1
(43) Pub. Date: Dec. 5, 2019

(54) HIGH CAPACITY PRINT STATION, METHOD OF MAKING A POLYMER COMPOSITE PART, AND POLYMER COMPOSITE PART

(71) Applicant: Corning Incorporated, Corning, NY (US)

(72) Inventors: Patrick Wilson Albor, Covington, PA (US); Roy Joseph Bourcier, Corning, NY (US); Eric Hamilton Starns, Painted Post, NY (US)

(21) Appl. No.: 15/993,044

(22) Filed: May 30, 2018

(51) Int. Cl. B29C 64/165; B32B 7/00; B32B 5/12; B32B 27/08; B29C 64/209; B33Y 10/00; B33Y 30/00

(52) U.S. Cl. CPC B29C 64/165; B32B 7/005; B32B 5/12; B32B 27/08; B29C 64/209; B29K 2101/12; B33Y 30/00; B32B 2260/046; B32B 2260/023; B32B 2305/08; B32B 2307/732; B33Y 10/00

(57) ABSTRACT

The disclosure relates to embodiments of an apparatus for producing polymer composite panels. The polymer composite panels include at least two layers of a polymeric matrix having discontinuous fibers embedded therein. The apparatus has a frame, a deposition bed, and a deposition head configured to move relative to the frame and over the deposition bed. The deposition head includes at least one extruder and a nozzle array. The extruder is configured to force the polymeric matrix and discontinuous fibers through the nozzle array and onto the deposition bed. The deposition head is configured to deposit an entire layer of a polymer composite panel on the deposition bed in a single pass so that the discontinuous fibers are oriented in the direction of the single pass. The disclosure also relates to embodiments of a method of forming a polymer composite panel and to embodiments of a polymer composite panel.

### BACKGROUND

This disclosure relates to an apparatus for performing an additive manufacturing technique to produce a polymer composite panel and more particularly to a print station and method for producing polymer composite panels. In the context of manufacturing and design, it is often desirable to produce low density structural parts, especially in automotive and aerospace applications. Additive manufacturing techniques have been investigated to produce polymer composite parts for these applications. However, conventional additive manufacturing techniques have low deposition rates, making them generally unsuitable for large-scale commercial manufacturing. Other conventional manufacturing techniques for producing polymer composite parts, such as blow molding, rotational molding, and other thermoforming methods, tend to develop undesirable directional mechanical properties, exhibit sub-optimal fiber strengthening as a result of random/undesired fiber alignment, and/or have difficulty maintaining uniform thickness in the finished part. Still other conventional manufacturing techniques, such as injection molding, require molds that are costly and time-consuming to make.

### SUMMARY

In one aspect, embodiments of an apparatus for producing polymer composite panels are provided. The polymer composite panels include at least two layers of a polymeric matrix having discontinuous fibers embedded therein. The apparatus has a frame, a deposition bed disposed within the frame, and a deposition head configured to move relative to the frame and over the deposition bed. The deposition head includes at least one extruder and a nozzle array. The at least one extruder is configured to force the polymeric matrix and discontinuous fibers through the nozzle array and onto the deposition bed. The deposition head is configured to deposit an entire layer of a polymer composite panel on the deposition bed in a single pass of the deposition head over the deposition bed in such a way that the discontinuous fibers are oriented substantially in the direction of the single pass.

In another aspect, embodiments of the disclosure relate to a method of forming a polymer composite panel. In the method, a deposition head is passed over a deposition bed in a first pass. A first layer of a polymer composite material is deposited on the deposition bed during the first pass of the deposition head over the deposition bed. A vertical distance between the deposition head and the deposition bed is increased. The deposition head is passed over the deposition bed in a second pass. A second layer of the polymer composite material is deposited on the first layer during the second pass of the deposition head over the deposition bed. The polymer composite material includes a polymeric matrix having discontinuous fibers embedded therein. The discontinuous fibers in the first layer are substantially arranged in a first orientation, and the discontinuous fibers in the second layer are substantially arranged in a second orientation. The second orientation forms a first angle of about 45° or about 90° relative to the first orientation

In still another aspect, embodiments of a polymer composite panel. The polymer composite panel has at least a first layer and a second layer. Each of the first layer and the second layer comprise a polymer composite material. The polymer composite material includes a polymeric matrix and discontinuous fibers embedded in the polymeric matrix. The discontinuous fibers of the first layer are substantially oriented in a first direction, and the discontinuous fibers of the second layer are substantially oriented in a second direction. The second direction forms an angle of at least about 45° with the first direction.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 depicts a print station, according to an exemplary embodiment.

FIG. 2 depicts a side view of a nozzle of an extruder of the print station, according to an exemplary embodiment.

FIG. 3 depicts a top view of the nozzle of FIG. 2, according to an exemplary embodiment.

FIG. 4 is a photograph of polymer composite strips produced from the nozzle of FIG. 2, according to an exemplary embodiment.

FIG. 5 depicts half of a nozzle array of the print station, according to an exemplary embodiment.

FIG. 6 depicts a top view of a nozzle array of the print station, according to an exemplary embodiment.

FIG. 7 depicts a bottom view of the nozzle array of FIG. 6, according to an exemplary embodiment.

FIG. 8 depicts a staggered nozzle array for a print station that produces wide strips of polymer composite, according to an exemplary embodiment.

FIG. 9 depicts a staggered nozzle array for a print station that produces narrow strips of polymer composite, according to an exemplary embodiment.

FIG. 10 depicts a cross-sectional view of a polymer composite strip taken perpendicular to the extrusion direction.

FIG. 11 depicts an exploded view of a layered polymer composite material, according to an exemplary embodiment.

FIG. 12 depicts a cross-sectional view of a two layered polymer composite material in the every other layer is rotated 90° relative to its adjacent layer.

FIG. 13 is a photograph of a polymer composite panel formed from four polymer composite layers arranged at 0°, 45°, −45°, and 90°.

FIG. 14 is a photograph of the polymer composite panel of FIG. 13 after vacuum forming.

FIG. 15 is a photograph of a polymer composite panel formed from two polymer composite layers and a sheet of polymer material.

FIG. 16 is a photograph of the polymer composite panel of FIG. 15 after vacuum forming.

FIG. 17 is a calendaring roll for flattening the polymer composite layers of the polymer composite panel during application, according to an exemplary embodiment.

FIG. 18 is a photomicrograph of a polymer composite panel after calendaring.

FIG. 19 is a photograph of a porous polymer composite panel.

### DETAILED DESCRIPTION

Referring generally to the figures, various embodiments of an additive manufacturing apparatus and technique for producing polymer composite panels are provided. Additionally, various embodiments of polymer composite panels are provided. As will be discussed more fully below, the additive manufacturing apparatus is a print station having multiple extruders that dispense polymer composite material through a nozzle array. Using the print station, an entire layer of a polymer composite panel is able to be printed in a single pass. That is, as compared to other additive technologies in which only a single line is traced in one pass in a first direction, the print station as disclosed herein is configured to deposit an entire sectional plane as the nozzle array makes one pass over a print bed in a single direction. Further, the print station allows for panels having unique physical and structural characteristics to be manufactured at near net-shape after thermoforming, which reduces waste and the time and cost to manufacture a composite part.

As used herein, a “polymer composite panel” refers to a structure having at least one layer defined by a polymeric matrix into which discontinuous fibers are embedded. In embodiments, polymer composite panels according to the disclosure may be multilayered such that the polymer composite panel includes multiple layers of a polymeric matrix into which discontinuous fibers are embedded. Further, in embodiments, polymer composite panels according to the disclosure may include skin layers or interlayers that do not include discontinuous fibers. Additionally, in embodiments, polymer composite panels according to the disclosure may be a porous structures defined by layers of spaced strips of polymer composite material. In general, the polymer composite panels described herein are intended to be thermoformed, e.g., vacuum formed, pressure formed, etc., after the polymer composite panel is printed. These and other embodiments will be described in greater detail below. However, the polymer composite panels disclosed herein are distinguishable from composites having continuous fibers or woven fibers or fabrics embedded in a polymeric matrix. In general, a “continuous fiber” is one in which the fiber spans the width or length or substantially the entire width or length of the structure being created. Further, such polymer composite panels are distinguishable from composites having discontinuous fibers embedded between polymer layers.

As mentioned, polymer composite panels as disclosed herein have at least one layer of a polymeric matrix into which discontinuous fibers are embedded. In various embodiments, the discontinuous fibers are formed from a material that is different from the material of the matrix. In certain embodiments, the fibers are elongate structures (e.g., that have a length at least five times the width of the fibers). In specific embodiments, the elongate fibers are formed from a non-polymeric fiber material and the matrix is a polymeric material.

In embodiments, discontinuous fibers are fibers having a length of at most 20 mm. In other embodiments, discontinuous fibers are fibers having a length of at most 2 mm, and in still other embodiments, discontinuous fibers are fibers having a length of at most 200 μm. In embodiments, the discontinuous fibers have a length of at least 20 μm. A variety of suitable materials are usable as discontinuous fibers. In exemplary embodiments, the discontinuous fibers include at least one of carbon fibers, glass fibers, aramid fibers, basalt fibers, cellulosic fibers, nylon fibers, quartz fibers, boron fibers, silicon carbide fibers, polyethylene fibers, or polyimide fibers. This list of fiber types is illustrative and non-limiting. As will be recognized by those of ordinary skill in the art from the present disclosure, other fiber types may be suitable depending on the needs of a particular application.

A variety of suitable materials are usable as the polymeric matrix. In exemplary embodiments, the polymeric matrix includes at least one of polyethylene terephthalate, glycol-modified polyethylene terephthalate, polylactic acid, acrylonitrile-butadiene-styrene, nylon, acrylic styrene acrylonitrile, thermoplastic polyurethane, polycarbonate, polypropylene, polyetherktetoneketone, polyether ether ketone, polyether imide, polyphenylsulfone, polysulfone, polyphenylene-sulfide, or polyvinylidene fluoride. This list of polymers is illustrative and non-limiting. As will be recognized by those of ordinary skill in the art from the present disclosure, other polymers may be suitable depending on the needs of a particular application. In embodiments, the discontinuous fiber has a loading fraction of up to 10 vol % of the polymer composite panel or layer. In other embodiments, the discontinuous fiber has a loading fraction of up to 25 vol %, and in still other embodiments, the discontinuous fiber has a loading fraction of up to 50 vol %. In the experimental embodiments discussed herein, the discontinuous fiber was carbon fiber having an average length of approximately 200 μm, and the polymeric matrix was glycol-modified polyethylene terephthalate. As used herein below, the carbon fiber reinforced, glycol-modified polyethylene terephthalate is referred to as “CFR-PETG.”

As mentioned above, an additive manufacturing apparatus and technique are disclosed herein for producing polymer composite panels as described. More specifically, the additive manufacturing apparatus is a print station that that allows for high yield rates by depositing a volume of polymer on a per hour basis. In exemplary embodiments, such as those described more fully below, the print station utilizes multiple extruders (e.g., up to 20 extruders) with a nozzle array that is capable of outputting about 90 kg of polymer composite material having a density of 1.4 g/cm³ per hour, which corresponds to an output volume of about 64,000 cm³ of polymer composite material per hour. Such yield is significantly higher than conventional fused deposition modeling extruders, which are limited to outputting a volume of about 750 cm³ per hour. Additionally, using embodiments of the print station disclosed herein, the polymer composite panel is able to incorporate high loading fractions of the discontinuous fiber and a longer length of discontinuous fiber is able to be used without experiences issues of nozzle clogging.

Advantageously, the print station and print techniques disclosed herein allow for the formation of panels that, after thermoforming, produce near net-shaped parts of arbitrary shapes and dimensions that require very little trimming. The ability to produce near net-shaped parts not only decreases manufacturing time but also reduces waste. In certain circumstances, polymer composite material that has been extruded has degraded properties if recycled, and therefore, waste material that is trimmed from the part must be discarded or reused with the understanding of the potential for degraded properties. Additionally, the production of near net-shaped parts reduces costs in terms of manufacturing time and waste.

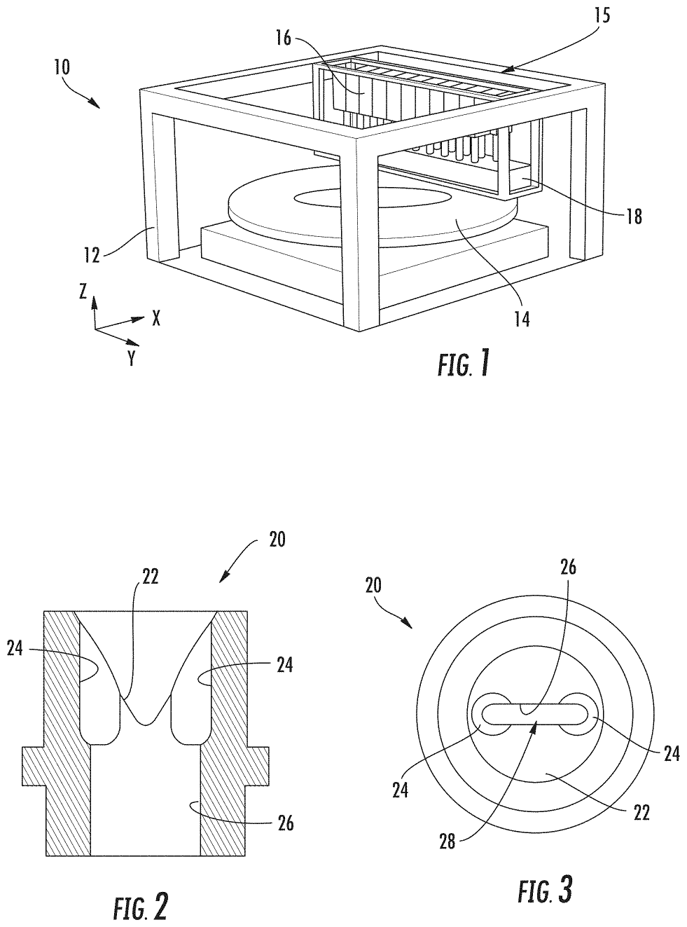

In FIG. 1, an embodiment of a print station 10 is depicted. As can be seen, the print station 10 includes a frame 12 in which a print bed 14 is situated. The frame 12 also includes a deposition head 15. The deposition head 15 is comprised of a plurality of extruders 16 feeding polymer composite into a nozzle array 18. In embodiments, each nozzle of a nozzle array 18 is fed molten polymer composite material by an extruder of the plurality of extruders 16. In other embodiments, a single extruder of the plurality of extruders 16 feeds molten polymer composite material to at least two nozzles of the nozzle array 18. In a single print station 10, the number of extruders and nozzles is scalable depending on the desired size of the polymer composite panel to be produced. For example, the plurality of extruders 16 can include up to 10 extruders, up to 30 extruders, or up to 50 extruders in embodiments. Further, in embodiments, the plurality of extruders 16 are fed by a single hopper, and in other embodiments, the plurality of extruders 16 are fed by multiple hoppers, which can contain the same or a different polymer composite material.

In embodiments, the print station 10 has at least three degrees of movement. In particular, the print bed 14 may rotate about axis Z and raise and lower along axis Z. Additionally, the deposition head 15 moves back and forth across the plane defined by the X and Y axes. Thus, for example, the print bed 14 and the deposition head 15 may be in a start position relative to each other. The deposition head 15 then passes over the print bed 14, depositing a first layer of polymer composite material. Thereafter, the print bed 14 may rotate a number of degrees and lower to a new vertical position relative to the deposition head 15. The deposition head 15 may then pass back over the print bed 14 depositing a second layer of polymer composite material. During each pass or during a portion of each pass, various nozzles within the nozzle array 18 may be open or closed and/or various extruders of the plurality of extruders 16 may be active or inactive. In this way, polymer composite material is applied only in regions where desired. As will be appreciated from this discussion, the deposition head 15 deposits an entire layer in each pass as opposed to tracing back-and-forth across the print bed 14 multiple times in order to deposit a single layer.

In embodiments, each nozzle in the nozzle array 18 deposits a strip of polymer composite material. The nozzles in the nozzle array 18 may be positioned such that the strips are close together or touching, or the nozzles in the nozzle array 18 may be positioned such that the strips have a predetermined spacing between them. FIG. 2 provides an exemplary embodiment of a nozzle 20 usable in the nozzle array 18. As depicted in FIG. 2, the nozzle 20 has a conical region 22, and during extrusion, the tapering of the conical region 22 facilitates fiber alignment in the polymer composite material. In the embodiment of FIG. 2, two cylindrical shoulder sections 24 are provided on opposite sides of the conical region 22. The shoulder sections 24 facilitate the transition of the nozzle 20 from a circular cross-section in the conical region 22 to an oblong cross section in channel 26. FIG. 3 provides a view looking down through conical region 22 of the nozzle 20. As can be seen in FIG. 3, the channel 26 of the nozzle 20 defines aperture 28 that is configured to produce a strip having a width greater than its thickness.

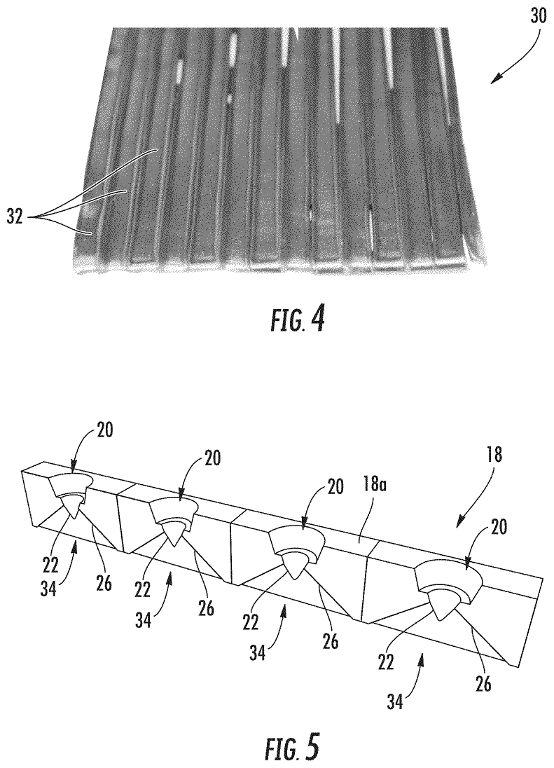

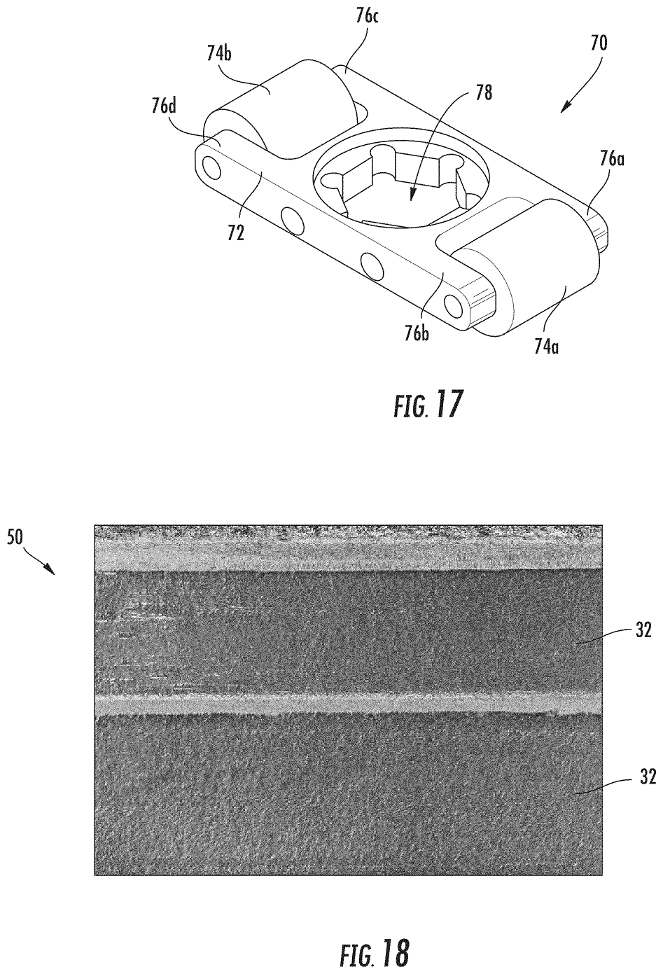

FIG. 4 depicts a polymer composite panel 30 comprised of a plurality of strips 32 produced via the nozzle 20. As can be seen, the strips 32 are substantially uniform in size and shape. In general, such strips 32 have a thickness of about 1 mm to about 2 mm and a width of about 10 mm. However, thicker or thinner and/or wider or narrower strips 32 can be produced using nozzles 20 of various sizes. For example, in embodiments, the nozzle 20 is configured to produce strips having a width of about 50 mm. In specific embodiments, each deposited layer of composite panel 30 is formed from a plurality of strips 32 deposited adjacent to and contacting each other such that strips 32 bond together forming a contiguous and continuous layer of material (e.g., as shown in FIG. 15, which is discussed more fully below). Bonding of the strips 32 to each other may be facilitated using a calendaring tool, such as shown in FIG. 17, which is discussed below.

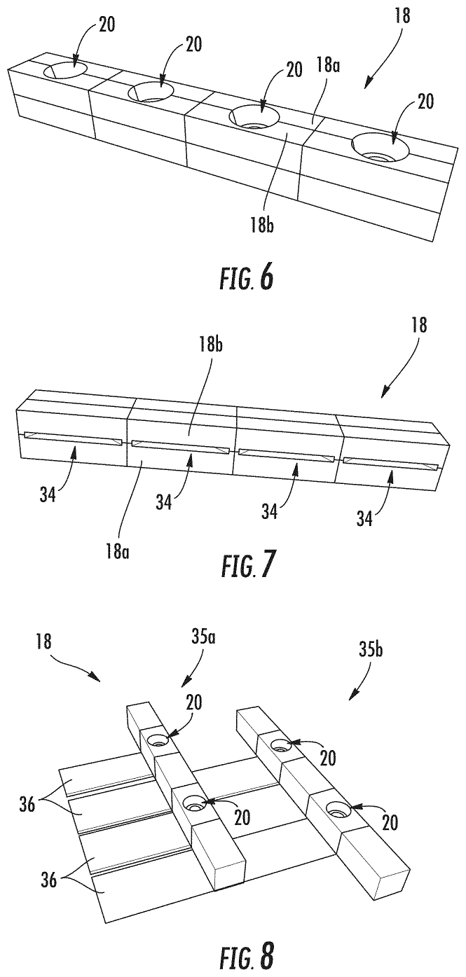

FIG. 5 depicts a first half 18a of the nozzle array 18. As can be seen, each nozzle 20 includes a conical region 22 that opens into a channel 26. In the embodiment depicted, the channels 26 fan outwardly from the conical region 22 so as to define a wide aperture 34. Accordingly, the nozzles 20 of the nozzle array 18 depicted in FIG. 5 produce a wider strip than, e.g., the strips depicted in FIG. 4, which were produced by the nozzle 20 of FIGS. 2 and 3. FIG. 6 depicts the first half 18a as joined to a second half 18b for a completed nozzle array 18. In this embodiment of the completed nozzle array 18, there are four nozzles 20. However, more or fewer nozzles 20 can be provided in other embodiments. FIG. 7 depicts a bottom side of the nozzle array 18 and the four wide apertures 34 defined by the first half 18a and the second half 18b.

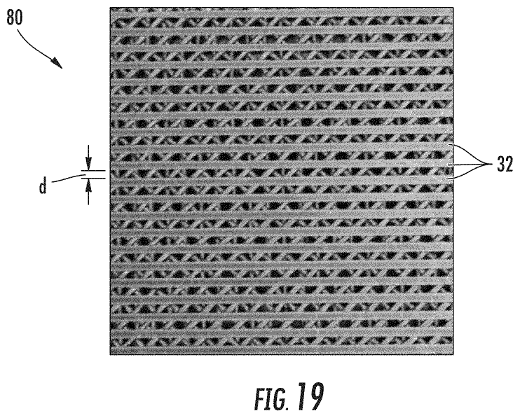

FIG. 8 depicts a staggered nozzle array 18 that includes a first nozzle block 35a and a second nozzle block 35b. Each of the nozzle blocks 35a, 35b includes two nozzles 20. However, the two nozzles 20 of the first nozzle block 35a are horizontally offset from the two nozzles 20 of the second nozzle block 35b. In this way, the nozzle array 18 allows more room for the plurality of extruders 16 (as depicted in FIG. 1). As can be seen in FIG. 8, the nozzle blocks 35a, 35b are each configured to produce wide strips 36 of polymer composite material. In another embodiment shown in FIG. 9, the two nozzle blocks 35a, 35b of the staggered nozzle array 18 are configured to produce thin strips 32 of polymer composite material. In exemplary embodiments, the nozzle array 18 of FIG. 9 is used to deposit layers of a composite panel formed from a plurality of such thin strips 32 that retain a space between each other. In this way, layers of spaced thin strips 32 deposited on top of other layers of spaced thin strips 32 build a porous structure as shown in FIG. 19, which is discussed more fully below.

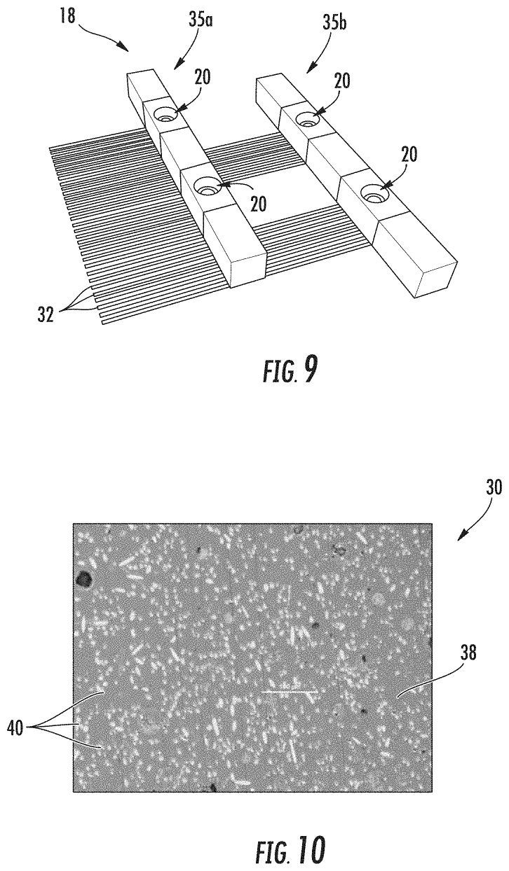

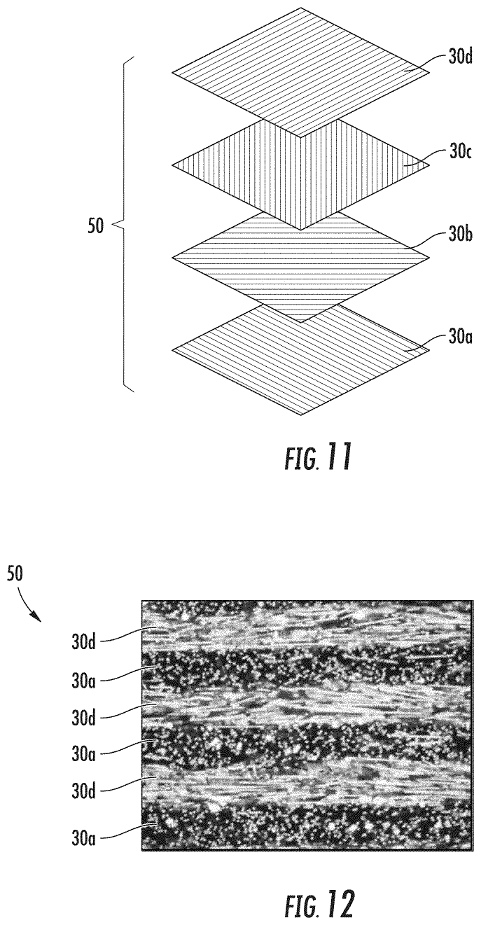

Advantageously, the nozzles 20 as shown in FIGS. 2, 3, and 5-9 produce highly oriented polymer composite layers 30 as shown in the cross-sectional view of FIG. 10, which depicts a plane perpendicular to the extrusion direction. As can be seen within a polymer matrix 38, fibers 40 are aligned in substantially the same direction. That is, most fibers 40 of the matrix 38 are aligned along the extrusion direction, which enhances the strength of a polymer composite layer 30 in the direction of fiber alignment. As shown in FIG. 11, this property of anisotropic strength in a single layer 30 can be utilized to produce a polymer composite panel 50 with isotropic strength by arranging multiple layers 30a, 30b, 30c, 30d at various angles relative to each other. In the exemplary embodiment shown in FIG. 11, the second layer 30b is rotated 45° relative to the first layer 30a (i.e., the first layer 30a being defined as 0°), the third layer 30a is rotated −45° relative the first layer 30a, and the fourth layer 30d is rotated 90° relative to the first layer 30a. During deposition of each layer 30a, 30b, 30c, 30d, the layers 30a, 30b, 30c, 30d maintain their thermal mass such that they bond to each other, and this bonding may be further enhanced by applying pressure, such as through calendaring, to the stack of layers 30a, 30b, 30c, 30d.

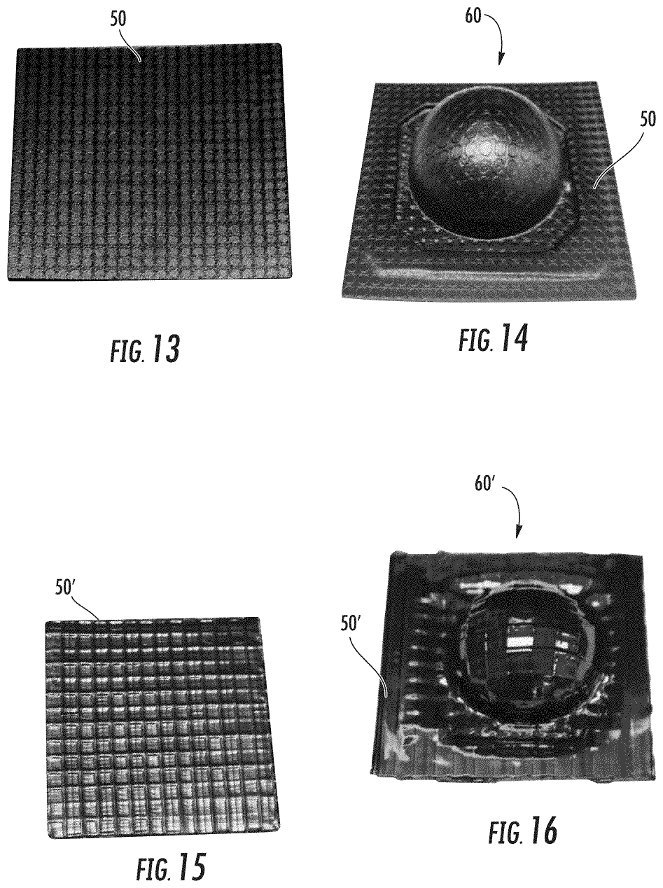

FIG. 12 provides a photomicrograph of a polymer composite panel 50 made of a first layer 30a and a second layer 30d in which the second layer is rotated 90° relative to the first layer 30a. As can be seen, the fiber orientation and high degree of alignment in each layer 30a, 30d is clearly defined.

FIG. 13 depicts a polymer composite panel 50 of CFR-PETG has dimensions of 125 mm wide by 125 mm long by 1 mm thick and includes four layers arranged at 0°, 45°, −45°, and 90° (e.g., as schematically shown in FIG. 11). Each layer was approximately 250 μm thick and was printed using a 400 μm wide round nozzle. The circles imprinted on the composite panel 50 of FIG. 13 were provided so that localized strains could be visualized after a forming operation. FIG. 14 depicts a formed polymer composite panel 60 after the polymer composite panel 50 of FIG. 13 was vacuum formed over a 75 mm steel hemisphere. As can be seen, equivalent biaxial strains of 0.8 were accommodated without any signs of localization. Indeed, the formed composite panel 60 shows highly uniform radial deformation consistent with the imposed geometry and no signs of localization or thinning.

FIG. 15 depicts another embodiment of a polymer composite panel 50′ in which two layers 30a, 30d of polymer composite strips 32 were deposited onto a 0.5 mm (20 mil) skin layer of PETG that was bonded to the print bed 14 of the print station 10. The strips 32 forming the layers 30a, 30d were printed using a slot nozzle 20, such as shown in FIGS. 2 and 3, that was 2 mm thick and 10 mm wide. The skin layer can be seen in FIG. 16. As can be seen in a comparison of the formed polymer composite panels 60, 60′ in FIGS. 14 and 16, the skin layer provides a glossier finish, and advantageously the skin layer can be used to impart additional properties to the polymer composite panel 50′. For instance, in embodiments, the skin layer facilitates removal of the polymer composite panel 50′ from the print bed 14. Further, in embodiments, the skin layer provides a desired surface finish, including not only a glossier finish but also different colors. Still further, in embodiments, the skin layer is a different polymer than the matrix material so as to impart a different mechanical or chemical property to the polymer composite panel 50′.

Returning to FIG. 15, the polymer composite panel 50′ has a waffle texture resulting from uneven thickness across the width of the strips during extrusion. That is, the strips were thicker at the ends than in the middle, producing a dumbbell cross-section. The nozzle shape can be configured to reduce the creation of such a cross-section, e.g., by widening the middle portion of the aperture 28 of the nozzle 20. Additionally, such unevenness can be compressed out of the layers by calendering each layer and/or the finished polymer composite panel 50′. Further, thermoforming the polymer composite panel 50′ also substantially removes the unevenness as can be seen in FIG. 16. As shown in FIG. 16, the formed polymer composite panel 60′ similarly was able to accommodate equivalent biaxial strains of 0.8 without any signs of localization.

As mentioned, bonding between layers and a reduction in unevenness can be provided by calendaring the layers during deposition. In this regard, FIG. 17 provides an embodiment of a calendaring tool 70 that attaches to a nozzle 20 (e.g., as shown in FIGS. 2 and 3). The calendaring tool 70 includes a frame structure 72 that supports a first roller 74a and a second roller 74b. The first roller 74a is supported by two support arms 76a, 76b that extend from the support structure 72 on either side of the first roller 74a. Similarly, the second roller 74b is supported by two support arms 76c, 76d that extend from the support structure 72 on either side of the second roller 74b. The two rollers 74a, 74b are provided, in embodiments, to allow for calendaring as the nozzle array 18 moves back-and-forth across the print bed. For attachment of the calendaring tool 70 to a nozzle 20, an aperture 78 is centrally provided in the support structure. In embodiments, the calendaring tool 70 is affixed to the nozzle 20 using one or more set screws. Such a calendaring tool 70 or a plurality of calendaring tools 70 can also be attached to a nozzle array 18 (e.g., as shown in FIGS. 1, 8, and 9). In such embodiments, the aperture 78 may be elongated to circumscribe the perimeter of the nozzle array 18. Further, the rollers 74a, 74b may also be elongated to span the width of the nozzle array 18 or a plurality of rollers 74a, 74b may be arranged along the width of the nozzle array 18.

FIG. 18 depicts a photomicrograph of a polymer composite panel 50 that had been rolled using a calendaring tool 70. The polymer composite panel 50 includes two strips 32 that have been bonded to each other at their edges. As shown in FIG. 18, the light gray zones between the strips 32 are deformed material joining the adjacent strips 32. The coloration results from slight variations in topography and lighting.

FIG. 19 depicts an embodiment of a porous polymer composite panel 80. As can be seen, the porous polymer composite panel 80 is comprised of multiple layers of strips 32 that are spaced a distance d apart. As can be seen, a first layer of the porous polymer composite panel 80 includes strips 32 oriented horizontally, a second layer that includes strips 32 oriented 45° relative to the strips 32 of the first layer, a third layer that includes strips 32 oriented −45° relative to the strips 32 of the first layer, and a fourth layer that includes trips 32 oriented 90° relative to the strips 32 of the first layer. Thus, the porous polymer composite panel 80 of FIG. 19 is similar to the polymer composite panel 50 of FIG. 11, but the space d between the strips 32 creates porosity, thereby further decreasing the density of the polymer composite panel.

The polymer composite panels as described herein can be used in a variety of different applications, particularly in applications that would benefit from lightweighting, such as automotive applications. Advantageously, polymer composite panels can be printed quickly and then thermoformed using standard thermoforming techniques, such as vacuum forming or pressure forming. Polymer composite panels can be built up from any number of layers. In embodiments, polymer composite panels are built up from a multiple of four layers (e.g., 4, 8, 12, 16, etc. layers) such that each sequence of four layers maintains the 0°, 45°, −45°, and 90° orientation to produce overall isotropic properties. In embodiments, parts fabricated from such polymer composite panels are generally meter-scale in length. Advantageously, such parts can more quickly be manufactured from the print station as disclosed herein than conventional additive manufacturing techniques. Exemplary embodiments of automotive parts that can be made from the disclosed polymer composite panels include, among others, seatbacks, floor pans, oil pans, hoods, spoilers, bumpers, fenders, wheels, roofs, door panels, and the like.

According to an exemplary embodiment, a composite sheet, as described above, includes a layer (e.g., sheet, quantity, or thickness of material) of discontinuous fibers (e.g., chopped fiber, acicular and/or elongate reinforcement elements) that are at least partially (e.g., mostly, fully) enveloped by a matrix (e.g., binder, glue, filler, continuous phase of composite), such as a polymer or thermoplastic, and at least partially distributed (e.g., mostly, evenly) throughout the matrix. In some such embodiments, the sheet is nonplanar, i.e. includes curvature, such as a sheet formed into the hood of an automobile, for example, or the article of FIG. 14.

Technology disclosed above (e.g., nozzle, feedstock, movement of the assembly) may orient the discontinuous fibers as the sheet or other article is formed. In some embodiments, as generally described above and shown in the figures (e.g., FIGS. 11-12), the discontinuous fibers of the layer are commonly aligned such that most of the discontinuous fibers of the layer (e.g., more than 50%, at least 60%, at least 80%, at least 95%) are lengthwise oriented within 15-degrees (e.g., within 10-degrees, within 5-degrees) of a direction extending along curvature of the sheet. Fibers of the layer may be arranged to form a solid continuous sheet (e.g., FIG. 11 laminates) or may be arranged with gaps between fibers of the layer, as shown in FIG. 19, forming a sheet or other article that includes a lattice when such a layer is stacked with other such layers.

As described above, the matrix may include a polymer, such as a thermoplastic that melts at a lower temperature than the fibers. The fibers may be inorganic, such as glass fibers. According to an exemplary embodiment, most of the discontinuous fibers are no longer than 10 mm in length (e.g., no longer than 5 mm, 3 mm) and/or have a widest cross-sectional dimension (e.g., diagonal, diameter, width) orthogonal to the length thereof that is less than 1.2 mm (e.g., less than 1 mm, 0.7 mm).

According to an exemplary embodiment, the layer is a first layer and the direction is a first direction, and the sheet further includes a second layer of the matrix and discontinuous fibers, wherein the discontinuous fibers of the second layer are commonly aligned such that most of the discontinuous fibers of the second layer are lengthwise oriented within 15-degrees of a second direction extending along curvature of the sheet. The second layer is stacked with and adjoining the first layer, such as at least partially contacting, at least partially overlapping, at least partially overlaying the first layer. In some such embodiments, the first and second directions are offset by at least 10-degrees, such as at least 15-degrees, at least 30-degrees. Such a sheet may be manufactured by compression molding, stamping in a die, for example, such as after heating the sheet to melt the matrix.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1-37. (canceled)

38. A composite sheet, comprising:
a layer of discontinuous fibers enveloped by and distributed throughout a matrix, wherein the sheet is nonplanar, and wherein the discontinuous fibers are commonly aligned such that most of the discontinuous fibers of the layer are lengthwise oriented within 15-degrees of a common direction extending along curvature of the sheet;
wherein the matrix comprises a polymer; and
wherein most of the discontinuous fibers are no longer than 5 mm in length and have a widest cross-sectional dimension orthogonal to the length thereof that is less than 1.2 mm.

39-59. (canceled)
